(19) United States
(12) Patent Application Publication
(10) Pub. No.: US 2025/0358514 A1
(43) Pub. Date: Nov. 20, 2025

(54) FOCUS CONTROL APPARATUS, IMAGING APPARATUS, AND FOCUS CONTROL METHOD

(71) Applicant: CANON KABUSHIKI KAISHA, Tokyo (JP)

(72) Inventor: YOSHIHITO TAMAKI, Kanagawa (JP)

(21) Appl. No.: 19/193,677

(22) Filed: Apr. 29, 2025

(30) Foreign Application Priority Data
May 15, 2024 (JP) 2024-079797

(51) Int. Cl. H04N 23/67; H04N 23/667

(52) U.S. Cl. CPC H04N 23/675; H04N 23/667

(57) ABSTRACT

A focus control apparatus includes one or more processors that execute a program stored in a memory, the one or more processors when executing the program cause the focus control apparatus to perform focus detection, control driving of a focus lens included in an optical system based on a focus detection result obtained by the focus detection, and set a movable range based on a search direction of the focus lens in response to a user's instruction and a position of the focus lens, wherein, in a case where an instruction regarding a first search direction is provided and thereafter an instruction regarding a second search direction different from the first search direction is provided, the movable range is set based on the second search direction and a first focus lens position when the instruction regarding the first search direction is provided.

### BACKGROUND

### Field

The present disclosure relates to focus adjustment (focus) control.

### Description of the Related Art

There is an imaging apparatus that performs a search operation to move a focus lens to search for an in-focus position. In Japanese Patent Application Laid-Open No. 2007-164051, an imaging apparatus includes first and second switches. When the first switch is turned on, the imaging apparatus executes search processing on a far-distance side using a present lens position as an end point on a near-distance side.

When the second switch is turned on, the imaging apparatus executes search processing on the near-distance side using the present lens position as an end point on the far-distance side.

A method discussed in Japanese Patent Application Laid-Open No. 2007-164051 is based on the premise of focus adjustment using a contrast detection method. If the method discussed in Japanese Patent Application Laid-Open No. 2007-164051 is applied to focus adjustment using a phase difference detection method, there is a possibility that the imaging apparatus detects a defocus amount in the vicinity of a start position of a search operation, and re-focuses on the start position of the search operation based on the defocus amount.

In Japanese Patent Application Laid-Open No. 2007-164051, a consideration is not given to a case where the first switch and the second switch are erroneously operated. Hence, there is a possibility that the imaging apparatus may not be able to perform an appropriate search operation for a quick focus on a subject as desired by a user.

### SUMMARY

The present disclosure has been made in consideration of the above situation and is directed to a focus control apparatus that performs a search operation in focus adjustment.

According to an aspect of the present disclosure, a focus control apparatus includes one or more processors that execute a program stored in a memory, the one or more processors when executing the program cause the focus control apparatus to perform focus detection, control driving of a focus lens included in an optical system based on a focus detection result obtained by the focus detection, and set a movable range based on a search direction of the focus lens in response to a user's instruction and a position of the focus lens, wherein, in a case where an instruction regarding a first search direction is provided and thereafter an instruction regarding a second search direction that is different from the first search direction is provided, the movable range is set based on the second search direction and a first focus lens position when the instruction regarding the first search direction is provided.

Further features of the present disclosure will become apparent from the following description of exemplary embodiments with reference to the attached drawings.

### BRIEF DESCRIPTION OF THE DRAWINGS

FIG. 1 illustrates a block diagram of a configuration of an imaging apparatus.

FIG. 2 illustrates a pixel array of an image pickup device.

FIG. 3A illustrates a plan view of a pixel.

FIG. 3B illustrates a cross-sectional view of the pixel.

FIG. 4 illustrates a diagram for describing pupil division.

FIG. 5 illustrates a diagram for describing a relationship between the image pickup device and pupil division.

FIG. 6 illustrates a diagram for describing a defocus amount and an image shift amount.

FIG. 7 illustrates a flowchart describing imaging processing.

FIG. 8 illustrates a flowchart describing search autofocus (AF) processing.

FIG. 9 illustrates a flowchart describing processing of calculating a focus lens movable range.

FIG. 10 illustrates a positional relationship between a subject and a background.

FIG. 11A illustrates a graph indicating a subject signal and a background signal when an imaging optical system focuses on the background.

FIG. 11B illustrates a graph indicating a subject signal and a background signal when the imaging optical system focuses on the subject.

FIG. 12 illustrates a relationship between a focus lens position and a defocus amount.

FIGS. 13A to 13D each illustrate a relationship among a search direction, a search start position, a focus lens position, a focus lens movable range, a defocus amount, and a focus lens driving amount in a case where an instruction regarding the search direction is provided and thereafter the instruction regarding the search direction is provided anew with respect to the identical direction.

FIGS. 14A and 14B each illustrate a relationship among the search direction, the search start position, the focus lens position, the focus lens movable range, the defocus amount, and the focus lens driving amount in a case where the instruction regarding the search direction is provided and thereafter the instruction regarding the search direction is provided anew with respect to an opposite direction.

### DESCRIPTION OF THE EMBODIMENTS

Exemplary embodiments of the present disclosure will be described with reference to drawings.

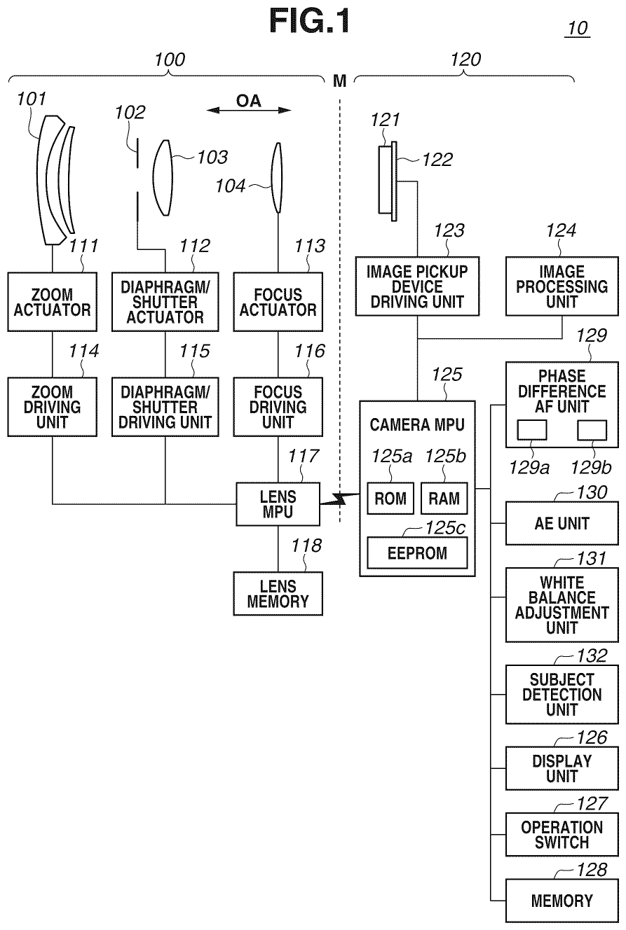

An imaging system 10 according to a first exemplary embodiment, which is illustrated in FIG. 1, is an interchangeable single-lens reflex digital camera system that performs autofocus using an imaging plane phase difference detection method (hereinafter referred to as imaging plane phase difference AF). The present exemplary embodiment and a second exemplary embodiment can be applied to a lens-integrated digital camera and a digital video camera, and also applied to a terminal device such as a tablet and a smartphone, and various kinds of imaging apparatuses such as a monitoring camera, an on-vehicle camera and a medical camera. A focus detection method is not limited to the imaging plane phase difference AF, and another focus detection method may be employed as long as information regarding a subject distance can be obtained. For example, a conceivable method is a Time of Flight (ToF) method of emitting light (infrared light or laser beams), measuring time until the light bounces off a subject and returns, and thereby calculating a distance. Another method attaches a radio frequency identification (RFID) tag or an ultra-wideband (UWB) tag to a subject, receiving a signal from the tag by an antenna, and identifying a position.

### <Configuration of Apparatus>

The imaging system 10 includes a lens unit 100 and a camera main body 120 as an imaging apparatus. The lens unit 100 is detachably connected to the camera main body 120 via a mount M indicated by a dotted line in the middle of FIG. 1.

The lens unit 100 includes an imaging optical system including a first lens group 101, a diaphragm 102, a second lens group 103, and a focus lens group (hereinafter referred to as a focus lens) 104.

The first lens group 101 is located closest to an object in the lens unit 100, and is secured to move forward and backward in an optical axis direction OA. The optical axis direction OA is hereinafter referred to as a Z-direction and a direction in which a subject is seen from a camera is hereinafter referred to as a positive direction. In the present exemplary embodiment, assume that a point of origin 0 of an axis in the Z-direction corresponds to a position of an image pickup device 122 in the camera main body 120, which will be described below.

The diaphragm 102 changes its aperture diameter to perform light amount adjustment. The diaphragm 102 functions as a mechanical shutter that controls exposure time at the time of still-image capturing. The diaphragm 102 and the second lens group 103 move forward and backward in the optical axis direction OA in an integrated manner, and move in conjunction with the first lens group 101 to implement a zoom function.

The focus lens 104 moves forward and backward in the optical axis direction OA. A subject distance (in-focus distance) at which the lens unit 100 is brought into focus changes depending on a position of the focus lens 104. In the present exemplary embodiment, autofocus is implemented by control of the position of the focus lens 104 in the optical axis direction OA.

The lens unit 100 includes a driving/control system (including devices, circuits, program codes, and others). The driving system includes a zoom actuator 111, a diaphragm/shutter actuator 112, a focus actuator 113, a zoom driving unit 114, a diaphragm/shutter driving unit 115, and a focus driving unit 116. The control system, which controls the drive system, includes a lens micro-processing unit (MPU) 117 and a lens memory 118.

The zoom actuator 111 drives the first lens group 101 and the second lens group 103 to move forward and backward in the optical axis direction OA, and performs zoom control to change an angle of view of the imaging optical system. The diaphragm/shutter actuator 112 controls the aperture diameter of the diaphragm 102 to adjust a light amount, and controls an opening/closing operation of the diaphragm 102 to control exposure time at the time of imaging. The focus actuator 113 moves the focus lens 104 forward and backward in the optical axis direction OA to perform autofocus, and has a function of detecting a present position (actual position) of the focus lens 104.

The zoom driving unit 114 drives the zoom actuator 111 according to a user's zoom operation or a control value of the lens MPU 117. The diaphragm/shutter driving unit 115 drives the diaphragm/shutter actuator 112. The focus driving unit 116 drives the focus actuator 113.

The lens MPU 117 performs calculation regarding the imaging optical system, and controls the zoom driving unit 114, the diaphragm/shutter driving unit 115, the focus driving unit 116, and the lens memory 118. The lens MPU 117 communicates command and data with the camera MPU 125 via the mount M. For example, the lens MPU 117 detects the present position of the focus lens 104, and notifies the camera MPU 125 of lens positional information in response to a request from the camera MPU 125. The lens positional information includes information such as a position of the focus lens 104 in the optical axis direction OA, a position and diameter of an exit pupil in the optical axis direction OA, and a position and diameter of a lens frame in the optical axis direction OA. The lens frame restricts a light flux of the exit pupil.

The lens MPU 117 controls the zoom driving unit 114, the diaphragm/shutter driving unit 115, and the focus driving unit 116 in response to a request from the camera MPU 125. Optical information necessary for the imaging plane phase difference AF in the present exemplary embodiment is preliminarily stored in the lens memory 118. For example, a defocus map indicating a correspondence relationship between the position or moving amount of the focus lens 104 and a defocus amount is stored in the lens memory 118. The defocus map is generated by calculation of the defocus amount at a position of each pixel in the image pickup device 122, which will be described below. In response to a request for changing the defocus amount by a predetermined amount from the camera MPU 125, the lens MPU 117 refers to the defocus map stored in the lens memory 118. The lens MPU 117 controls the focus actuator 113 to move the focus lens 104 by a distance corresponding to the predetermined amount.

The camera MPU 125 executes the program stored in a ROM 125a, the lens memory 118, or the like to control the operation of the lens unit 100. Optical information regarding the imaging optical system and the like is also stored in the lens memory 118.

The camera main body 120 includes an optical low-pass filter 121, the image pickup device 122, and the driving/control system, which will be described below. The optical low-pass filter 121 reduces false colors and moire in a captured image.

The image pickup device 122 includes, for example, a complementary metal-oxide semiconductor (CMOS) image sensor and its peripheral circuit.

In the CMOS image sensor, each pixel is provided with a photoelectric conversion device that receives light. The CMOS image sensor includes a pixel group (imaging plane) in which a plurality of unit pixels is two-dimensionally arrayed with each pixel serving as a unit pixel.

The image pickup device 122 includes a plurality of focus detection pixels that receives light fluxes that pass through respective pupil regions of different imaging optical systems, and perform independent signal output from each pixel. This enables detecting (calculating) a defocus amount using imaging plane phase difference AF. The image pickup device 122 includes a plurality of imaging pixels. Each of the imaging pixel receives a light flux passing through an entire region of the exit pupil of the imaging optical system that forms an image of a subject and generates an image signal of the subject.

The driving/control system of the camera main body 120 includes an image pickup device driving unit 123, an image processing unit 124, the camera MPU 125, a display unit 126, an operation switch 127, a memory 128, and a phase difference AF unit 129. The driving/control system of the camera main body 120 also includes an auto exposure (AE) unit 130, a white balance adjustment unit 131, and a subject detection unit 132.

The image pickup device driving unit 123 controls a charge accumulation operation of the image pickup device 122, converts an image signal read out from the image pickup device 122 into a digital signal, and transmits the digital signal to the camera MPU 125. The image processing unit 124 performs various kinds of image processing, such as gamma conversion, color interpolation, and Joint Photographic Experts Group (JPEG) compression, on the image signal read out from the image pickup device 122. The image processing unit 124 generates a signal for imaging plane phase difference AF (focus detection signal), which will be described below, a signal for exposure adjustment, a signal for white balance adjustment, and a signal for subject detection.

The camera MPU 125 as a control unit is a computer that includes at least one microprocessor. The camera MPU 125 performs calculation regarding the camera main body 120, and controls the image pickup device driving unit 123, the image processing unit 124, the display unit 126, the operation switch 127, the memory 128, and the phase difference AF unit 129. The camera MPU 125 communicates with the lens MPU 117 via a signal line located in the mount M. With this configuration, the camera MPU 125 issues a request to the lens MPU 117 for acquiring the lens position, issues a request for zoom driving, diaphragm driving, and lens driving in a predetermined driving amount, and issues a request for acquiring optical information unique to the lens unit 100.

The read-only memory (ROM) 125a, a random-access memory (RAM) 125b, and an electrically erasable programmable read-only memory (EEPROM) 125c are located in the camera MPU 125. The ROM 125a stores a program for controlling a camera operation. The RAM 125b stores variables. The EEPROM 125c stores various types of parameters. The camera MPU 125 reads out the program stored in the ROM 125a, loads the program in the RAM 125b, and executes focus adjustment processing, subject detection processing, exposure adjustment processing, and white balance adjustment processing according to the program.

The display unit 126 includes a display device such as a liquid crystal display (LCD) panel and an organic electroluminescent (EL) panel, and displays various kinds of information regarding an operation mode set in the camera main body 120. The operation mode includes a static-image capturing mode, a moving-image capturing mode, and a playback mode to play a captured image stored in the memory 128.

The operation switch 127 includes a shutter switch, a power switch, a zoom switch, a mode changeover switch, and a search switch (instruction means). The memory 128 is a flash memory that is detachably mounted on a camera, and records captured images. In the present exemplary embodiment, the description references the operation switch 127 as the mechanism for instructing search, but the mechanism for instructing search is not limited to the operation switch 127. For example, the imaging system 10 may have a configuration in which a ring member that can be rotationally operated by a user is attached to an outer periphery of a lens barrel, and information regarding an operation amount (a rotational direction and an amount of rotation) is notified by the lens MPU 117 to the camera MPU 125, whereby whether an instruction regarding search has been provided is determined. The instruction regarding search includes an instruction regarding start of the search AF processing and an instruction regarding a search direction (driving direction of the focus lens 104).

The phase difference AF unit 129 as a focus detection mechanism performs focus detection using an imaging plane phase difference detection method based on focus detection signals as a pair of focus detection image signals that are respectively obtained from the image pickup device 122 and the image processing unit 124, and that have respective parallaxes. Specifically, the image processing unit 124 performs correlation calculation on a pair of pieces of phase difference image data generated from the pair of focus detection signals, and calculates an image shift amount (phase difference) between the pair of pieces of phase difference image data. The image processing unit 124 converts the image shift amount into a defocus amount to detect the defocus amount. The phase difference AF unit 129 uses the detected defocus amount (focus detection result) to perform focus adjustment (AF) processing to control the position of the focus lens 104. The phase difference AF unit 129 may perform focus detection according to, instead of the imaging plane phase difference detection method, a phase difference detection method using a focus detection sensor other than the image pickup device 122.

The phase difference AF unit 129 in the present exemplary embodiment includes a signal generation block 129a and a calculation block 129b. The signal generation block 129a generates first and second focus detection signals, which will be described below. The calculation block 129b calculates a phase difference between the first and second focus detection signals and calculates a defocus amount from the phase difference. At least part of the phase difference AF unit 129 (the signal generation block 129a or part of the calculation block 129b) may be included in the camera MPU 125. AF processing (focus control processing) executed by the camera MPU 125 and the phase difference AF unit 129 will be described below. The camera MPU 125 and the phase difference AF unit 129 constitute a focus control apparatus.

The subject detection unit 132 performs subject detection processing to detect a type, part, and state of the subject (detection type), a position and size of the subject (detection region), or the like based on a signal for subject detection generated by the image processing unit 124.

The AE unit 130 performs light metering based on the signal for exposure adjustment obtained from the image pickup device 122 and the image processing unit 124 to control an exposure condition. Specifically, the AE unit 130 calculates an exposure amount with a currently set aperture value, currently set shutter speed, and currently set International Standards Organization (ISO) sensitivity, calculates an appropriate aperture value, appropriate shutter speed, and appropriate ISO sensitivity based on a difference between the calculated exposure amount and a preliminarily set appropriate exposure amount, and thereby sets the appropriate aperture value, the appropriate shutter speed, and the appropriate ISO sensitivity as an exposure condition. With this configuration, automatic exposure adjustment (AE) is implemented.

The white balance adjustment unit 131 performs white balance adjustment processing based on the signal for white balance adjustment obtained from the image pickup device 122 and the image processing unit 124. Specifically, the white balance adjustment unit 131 adjusts color weighting based on a difference between a white balance parameter acquired from the signal for white balance adjustment and a preliminarily set appropriate white balance parameter. With this configuration, automatic white balance adjustment (AWB) is implemented.

A camera main body 120 according to the present exemplary embodiment executes AF, AE, AWB, and subject detection in combination, and selects a position at which AF, AE, or AWB is performed in an imaging range depending on a subject detection result.

### <Configuration of Image Pickup Device>

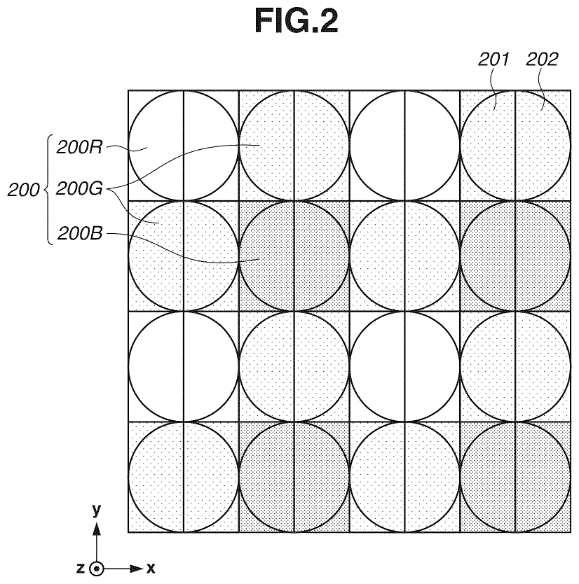

FIG. 2 illustrates an array of imaging pixels in a range of four columns×four rows in the image pickup device 122 as a two-dimensional CMOS sensor, and illustrates an array of focus detection pixels in a range of eight columns×four rows. Out of an imaging pixel group 200 composed of two columns×two rows illustrated in FIG. 2, an imaging pixel 200R having red (R) spectral sensitivity is disposed on the upper left, an imaging pixel 200G having green (G) spectral sensitivity is located on each of the upper right and the lower left, and an imaging pixel 200B having blue (B) spectral sensitivity is disposed on the lower right. Each imaging pixel is configured to include a first focus detection pixel 201 and a second focus detection pixel 202 in an array of two columns×one row.

Disposing multitudes of such imaging pixel groups 200 on the imaging plane makes it possible to acquire a captured image and a focus detection signal.

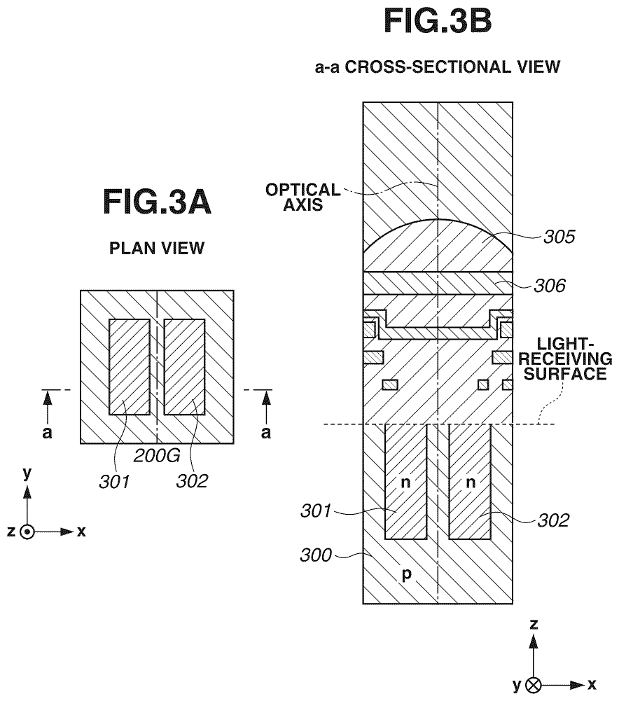

FIG. 3A illustrates one imaging pixel (hereinafter simply referred to as a pixel) 200G in the image pickup device 122 illustrated in FIG. 2 when viewed from a light-receiving surface (+z side) of the image pickup device 122. FIG. 3B illustrates a cross section when an a-a cross section in FIG. 3A is viewed from a −y side.

The pixel 200G is provided with a microlens 305 for condensing incident light, and photoelectric conversion units 301 and 302 that are obtained by division of a photoelectric conversion unit into halves in an x-direction. The photoelectric conversion units 301 and 302 respectively correspond to the first focus detection pixel 201 and the second focus detection pixel 202 illustrated in FIG. 2.

Each of the photoelectric conversion units 301 and 302 may be a p-i-n structure photodiode in which an intrinsic layer is interposed between a p-type layer and an n-type layer, or a p-n junction photodiode in which the intrinsic layer is omitted. The pixel 200G is provided with a color filter 306 between the microlens 305 and each of the photoelectric conversion unit 301 and the photoelectric conversion unit 302. Spectral transmittance of the color filter 306 may be changed depending on the photoelectric conversion units 301 and 302 or the color filter 306 may be omitted.

Light incident on the pixel 200G is condensed by the microlens 305, dispersed by the color filter 306, and thereafter received by the photoelectric conversion units 301 and 302. In the photoelectric conversion units 301 and 302, a pair of an electron and a hole is generated according to an amount of received light and separated in a depletion layer. Thereafter, electrons having a negative charge are accumulated in an n-type layer, while holes are discharged to the outside of the image pickup device 122 via a p-type layer connected to a constant voltage source, which is not illustrated.

Electrons accumulated in the n-type layer of each of the photoelectric conversion units 301 and 302 are transferred to a static capacitance unit (FD) via a transfer gate, and converted into a voltage signal.

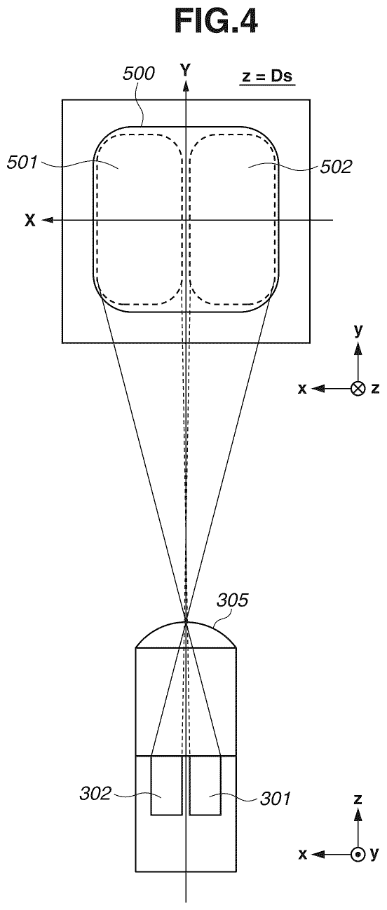

FIG. 4 illustrates a correspondence relationship between a pixel structure of the image pickup device 122 illustrated in FIG. 3 and pupil division.

FIG. 4 illustrates a cross section of a pixel structure of the image pickup device 122 illustrated in FIG. 3A when viewed from a +y side and a pupil surface of the image pickup device 122 (pupil distance Ds). FIG. 4 illustrates an x-axis and a y-axis in the cross section of the image pickup device 122 in a manner in which those in FIG. 3 are reversed so that the x-axis and the y-axis are brought into correspondence with coordinate axes of the pupil surface of the image pickup device 122.

In FIG. 4, a first pupil partial region 501 is a region that has an approximately conjugate relationship with a light-receiving surface of the photoelectric conversion unit 301 due to the microlens 305 and in which light can be received by the first focus detection pixels 201. The centroid of the light-receiving surface of the photoelectric conversion unit 301 is decentered in the −x direction. A second pupil partial region 502 is a region that has an approximately conjugate relationship with a light-receiving surface of the photoelectric conversion unit 302 due to the microlens 305 and in which light can be received by the second focus detection pixels 202. The centroid of the light-receiving surface of the photoelectric conversion unit 302 is decentered in the +x direction. In FIG. 4, a pupil region 500 including the first pupil partial region 501 and the second pupil partial region 502 is a region in which light can be received by the entire pixel 200G that combines the photoelectric conversion units 301 and 302 (the first focus detection pixel 201 and the second focus detection pixel 202).

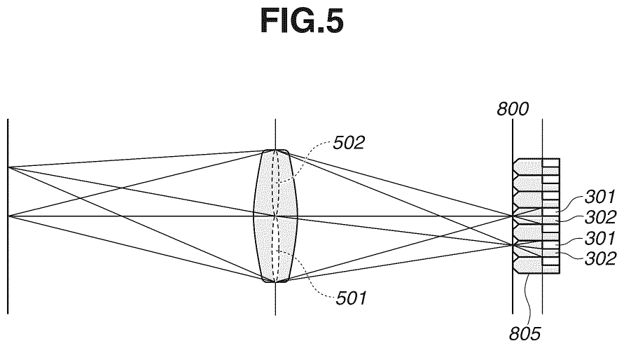

As illustrated in FIG. 5, respective light fluxes that pass through the first pupil partial region 501 and the second pupil partial region 502, which are different regions in the pupil region 500 of the imaging optical system, are incident on corresponding pixels on an imaging plane 800 at different angles, and respectively received by the first focus detection pixel 201 and the second focus detection pixel 202. FIG. 5 illustrates an example in which the pupil region is divided into halves in a horizontal direction by pupil division, but may be divided in a perpendicular direction.

Photoelectric conversion signals from focus detection pixels 201 in a plurality of pixels are combined to generate a first focus detection signal, and photoelectric conversion signals from second focus detection pixels 202 are combined to generate a second focus detection pixel. Photoelectric conversion signals from the first focus detection pixel 201 and the second focus detection pixel 202 are added in each pixel, whereby an imaging signal with a resolution of effective pixels N is generated. The second focus detection signal may be generated by subtraction of the first focus detection signal from the imaging signal.

In the above description of the image pickup device 122, each pixel of the image pickup device 122 has the configuration of including a plurality of photoelectric conversion units, the photoelectric conversion units 301 and 302, with respect to one microlens 305, and outputting focus detection signals from the photoelectric conversion units 301 and 302 and the image generation signal, but the configuration is not limited to the example. For example, the image pickup device 122 may have a configuration including imaging pixels used for image generation and focus detection pixels used for focus adjustment.

### <Relationship Between Defocus Amount and Image Shift Amount>

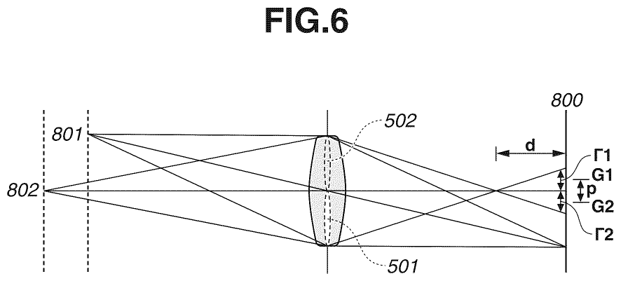

FIG. 6 illustrates a diagram for describing a relationship between a defocus amount and an image shift amount between the first focus detection signal and the second focus detection signal. As illustrated also in FIG. 5, the pupil region of the imaging optical system is divided in half, into the first pupil partial region 501 and the second pupil partial region 502. Regarding a defocus amount d, a distance from an image forming position of a subject image to the imaging plane 800 is |d|, and a front-focus state where the image forming position of the subject image is closer to a subject than the imaging plane 800 is indicated by a negative sign (d<0). A back-focus state where the image forming position of the subject image is on the opposite side of the subject on the imaging plane 800 is indicated by a negative sign (d>0). An in-focus state where the image forming position of the subject image is on the imaging plane 800 is indicated by d=0. In FIG. 6, a subject 801 represents a subject in the in-focus state (d=0), and a subject 802 represents a subject in the front-focus state (d<0). The front-focus state (d<0) and the back-focus state (d>0) are collectively referred to as a defocus state (|d|>0).

In the front-focus state (d<0), respective light fluxes that pass through the first pupil partial region 501 and the second pupil partial region 502 out of light fluxes from the subject 802 are condensed once and thereafter spread to have widths Γ1 and Γ2 respectively centering on centroid positions G1 and G2 of the light fluxes, and are formed as blurred images on the imaging plane 800. Light of the blurred images is received by the first focus detection pixel 201 and the second focus detection pixel 202, whereby the first focus detection signal and the second focus detection signal are generated. Thus, the first focus detection signal is recorded as a subject image of the subject 802 having the width Γ1 at the centroid position G1 on the imaging plane 800, and the second focus detection signal is recorded as a subject image of the subject 802 having the width Γ2 at the centroid position G2 on the imaging plane 800.

The widths Γ1 and Γ2 of the subject images increase in approximately proportion to an increase of a value |d| of the defocus amount d. Similarly, a value |p| of an image shift amount p between the first focus detection signal and the second focus detection signal (a difference between the centroid positions of the light fluxes G1−G2) also increases in approximately proportion to an increase of the value |d| of the defocus amount d. The same applies to the back-focus state (d>0) except that a direction of an image shift between the first focus detection signal and the second focus detection signal is opposite to that in the front-focus state.

The phase difference AF unit 129 converts the image shift amount into the defocus amount d using a conversion coefficient that is calculated based on a distance (base length) between the first focus detection pixel 201 and the second focus detection pixel 202 due to a relationship in which the image shift amount between the first focus detection signal and the second focus detection signal increases with the increased defocus amount.

### <Imaging Processing>

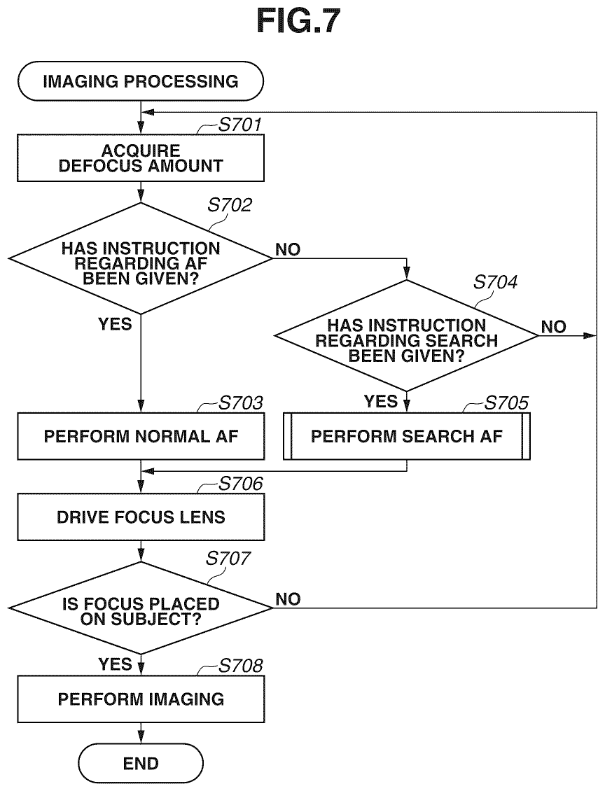

FIG. 7 illustrates a flowchart describing imaging processing to be executed by the camera MPU 125 according to a program in the present exemplary embodiment.

In step S701, the camera MPU 125 causes the phase difference AF unit 129 to perform focus detection based on a focus detection signal output from the image pickup device 122 and acquires a defocus amount and its reliability as a focus detection result. Assume that the defocus amount includes a defocus direction. The camera MPU 125 also generates a captured image based on an image signal output from the image pickup device 122 and displays the captured image on the display unit 126.

In step S702, the camera MPU 125 determines whether an instruction regarding AF has been provided. In a case where the instruction regarding AF has been provided (YES in step S702), the processing proceeds to step S703. In a case where the instruction regarding AF has not been provided (NO in step S702), the processing proceeds to step S704.

In step S703, the camera MPU 125 executes normal AF (imaging plane phase difference AF) processing, and sets a driving amount of the focus lens 104 (hereinafter referred to a focus lens driving amount) according to the defocus amount acquired in step S701. The processing then proceeds to step S706.

In step S704, the camera MPU 125 determines whether an instruction regarding search has been provided by the user's operation of a search switch in an operation switch 127. In the present exemplary embodiment, a description will be provided of a case where an instruction regarding a search direction is provided, and thereafter the instruction for the search direction is provided anew. Details about an operation for instructing the search direction will be described below. In a case where the instruction regarding search has been provided (YES in step S704), the processing proceeds to step S705. In a case where the instruction regarding search has not been provided (NO in step S704), the processing returns to step S701.

In step S705, the camera MPU 125 executes the search AF processing, and thereafter the processing proceeds to step S706. The search AF processing will be described below.

In step S706, the camera MPU 125 transmits the focus lens driving amount set in step S703 or step S705 to the lens MPU 117 and causes the lens MPU 117 to drive the focus lens 104.

In step S707, the camera MPU 125 determines whether the imaging optical system focuses on the subject. In a case where the camera MPU 125 determines that the imaging optical system has focused on the subject (YES in step S707), the processing proceeds to step S708. In a case where the camera MPU 125 determines that the imaging optical system has not focused on the subject (NO in step S707), the processing returns to step S701.

In step S708, the camera MPU 125 executes imaging for recording. When processing of recording an image ends, the present processing ends.

### <Search AF Processing>

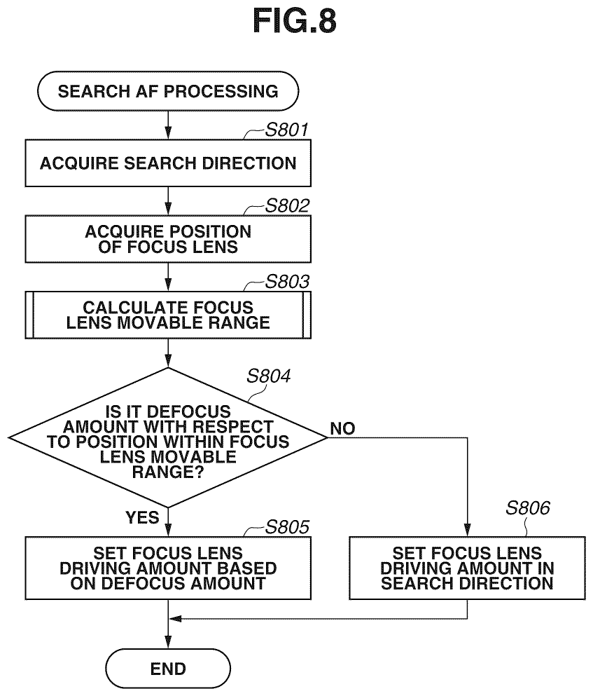

FIG. 8 illustrates a flowchart describing the search AF processing (focus control method) executed in step S705. In the search AF (processing), the camera MPU 125 performs a search operation (hereinafter simply referred to as search) of performing focus detection with a predetermined period while moving the focus lens 104 to search for an in-focus position of the focus lens 104. The camera MPU 125 moves the focus lens 104 to the in-focus position identified by the search.

In step S801, the camera MPU 125 acquires information regarding the search direction in the instruction regarding search determined in step S704 in FIG. 7.

In step S802, the camera MPU 125 acquires information regarding a present position (search start position) of the focus lens 104 from the lens MPU 117.

In step S803, the camera MPU 125 calculates a movable range of the focus lens 104 (hereinafter referred to as a focus lens movable range). Calculation of the focus lens movable range will be described below.

In step S804, the camera MPU 125 determines whether the defocus amount acquired in step S701 in FIG. 7 is a defocus amount with respect to a position in the focus lens movable range calculated in step S803. In other words, the camera MPU 125 determines whether a target position of the focus lens 104 in a case where the focus lens 104 is driven by the focus lens driving amount based on the defocus amount is within the focus lens movable range. In a case where the defocus amount with respect to the position in the focus lens movable range is acquired (the target position is within the focus lens movable range) (YES in step S804), the processing proceeds step S805. In a case where the acquired defocus amount is not the defocus amount with respect to the position within the focus lens movable range (NO in step S804), the processing proceeds step S806. In a case where reliability of the defocus amount is low and not usable, the camera MPU 125 determines that the acquired defocus amount is not the defocus amount within the focus lens movable range.

In step S805, the camera MPU 125 sets the focus lens driving amount based on the defocus amount acquired in step S701. The present processing then ends.

In step S806, the camera MPU 125 sets a predetermined focus lens driving amount in the search direction acquired in step S801 without using the defocus amount acquired in step S701. The predetermined focus lens driving amount is a driving amount at the time of search, and may be set depending on a period of focus detection, an imaging distance, an aperture value, an imaging mode, or the like. After step S806, the present processing ends.

### <Calculation of Focus Lens Movable Range>

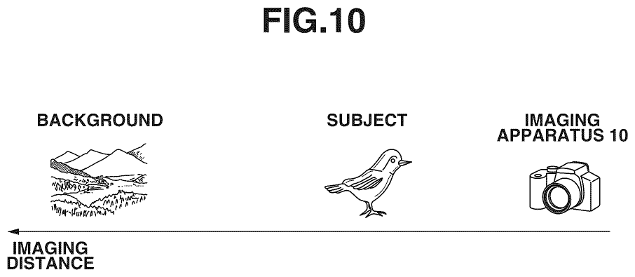

The focus lens movable range in step S803 in FIG. 8 will now be described. FIG. 10 illustrates a positional relationship between a subject and a background. The subject is located at a position that is close to the imaging system 10, and the background is located at a position that is sufficiently far from the imaging system 10.

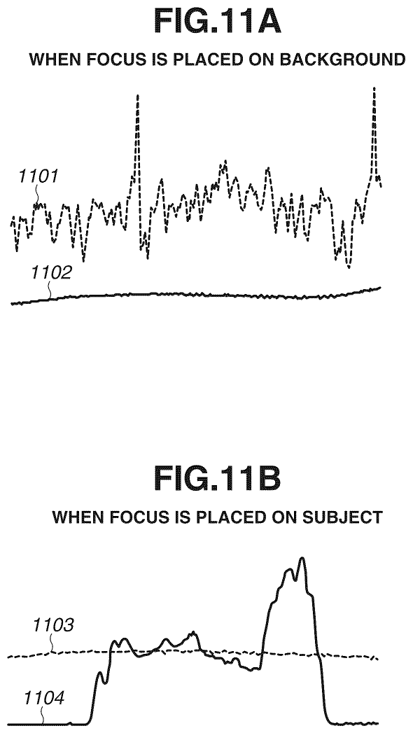

FIGS. 11A and 11B each illustrate a signal indicating the subject (hereinafter referred to as a subject signal) and a signal indicating the background (hereinafter referred to as a background signal) that are acquired from the image pickup device 122 in a case where the subject and the background are in the positional relationship illustrated in FIG. 10. FIG. 11A illustrates a subject signal 1102 and a background signal 1101 in a case where the imaging optical system focuses on the background. FIG. 11B illustrates a subject signal 1104 and a background signal 1103 in a case where the imaging optical system focuses on the subject. In reality, the subject signal and the background signal are acquired from the image pickup device 122 as a signal obtained by combining the subject signal and the background signal, but are illustrated herein as separate signals.

In a background in-focus state illustrated in FIG. 11A, the background signal 1101 has high contrast, and the subject signal 1102 has extremely low contrast. Hence, in the background in-focus state, the imaging optical system is significantly influenced by the background signal 1101, and detects a defocus amount with respect to the background as the focus detection result. In contrast, in a subject in-focus state illustrated in FIG. 11B, the subject signal 1104 has high contrast, and the background signal 1103 has extremely low contrast. Hence, in the subject in-focus state, the imaging optical system is significantly influenced by the subject signal 1104, and detects a defocus amount with respect to the subject as a focus detection result.

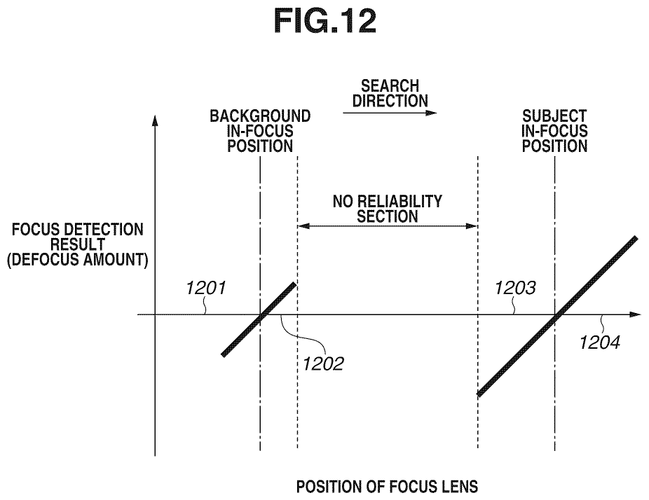

FIG. 12 illustrates a relationship between the focus lens position and the focus detection result in a case where the subject and the background are in the positional relationship illustrated in FIG. 10. An abscissa axis indicates the focus lens position and an ordinate axis indicates the defocus amount. The search direction is a direction from a side where an imaging distance is long (background) to a side where an imaging distance is short (subject).

In a case where the focus lens position is in the vicinity of the background in-focus position (1201 and 1202), the imaging optical system is significantly influenced by the background signal and detects the defocus amount with respect to the background as described above.

In contrast, in a case where the focus lens position is in the vicinity of the subject in-focus position (1203 and 1204), the imaging optical system is significantly influenced by the subject signal, and detects the defocus amount with respect to the subject. Since each of the background signal and the subject signal has low contrast in a section between the vicinity of the background in-focus position and the vicinity of the subject in-focus position, reliability of the defocus amount becomes low, and it is not possible to detect the defocus amount that is usable in AF.

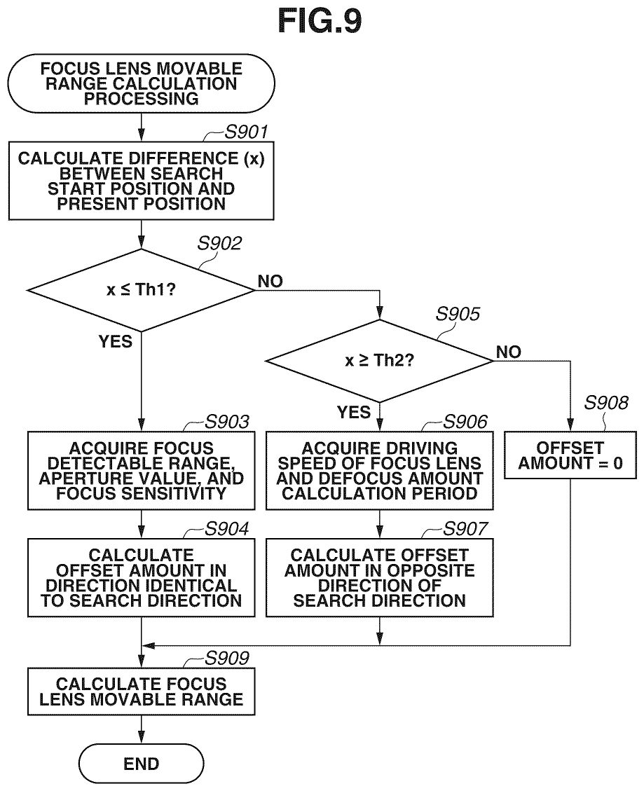

FIG. 9 illustrates a flowchart describing processing of calculating the focus lens movable range performed by the camera MPU 125. In step S901, the camera MPU 125 calculates a difference x between the search start position of the focus lens 104, which is acquired in step S802 at the start of search AF (at start of search), and the present position of the focus lens 104 acquired in step S802 in a present frame.

In step S902, the camera MPU 125 determines whether the difference x is a predetermined first threshold Th1 or less. In a case where the difference x is the first threshold Th1 or less (YES in step S902), the processing proceeds step S903. In a case where the difference x is not the first threshold Th1 or less (NO in step S902), the processing then proceeds step S905.

In step S903, the camera MPU 125 acquires a focus detectable range of the phase difference AF unit 129, and acquires the set aperture value and the set focus sensitivity (optical information regarding the imaging optical system) from the lens MPU 117. The focus detectable range corresponds to an image blurring amount (spread amount of a subject image) that is detectable by the phase difference AF unit 129. The focus sensitivity represents a relationship (ratio) between a unit driving amount of the focus lens 104 and a change amount of the defocus amount.

In step S904, the camera MPU 125 calculates an offset amount in a direction identical to the search direction acquired in step S801 based on the difference x calculated in step S901, and a focus detectable range R, an aperture value F, and focus sensitivity S acquired in step S903. The offset amount is a driving amount of the focus lens 104 to be calculated in consideration of a case where the search start position is in an opposite direction of the search direction with respect to the background in-focus position, and is calculated by, for example, the following Expression (1), where d represents a predetermined gain value:

$$Offset amount = α ( R / x ) FS \qquad ( 1 )$$

In a case where there occurs an image blurring amount that exceeds the focus detectable range with respect to a subject in the vicinity of the search start position, it is not possible to obtain a focus detection result with respect to the subject. Hence, there is no need for setting an offset amount that causes the image blurring amount that exceeds the focus detectable range. Thus, in such a case, the offset amount is set using the focus detectable range as a reference.

With increasing distance of the present position of the focus lens 104 from the search start position, it is more likely that the present position goes past the background focus in-focus position. Hence, the offset amount is made smaller with increasing distance of the present position from the search start position so as to be inversely proportional to the difference x between the search start position and the present position. This prevents setting of a too large offset amount. The aperture value F is used for conversion of the image blurring amount into the defocus amount, and the focus sensitivity is used for conversion of the defocus amount into the focus lens driving amount. Expression (1) is an example of an expression for calculating the offset amount, and the offset amount may be calculated by another method. After step S904, the processing proceeds to step S909.

In step S909, the camera MPU 125 calculates the focus lens movable range based on the present position of the focus lens 104, the offset amount calculated in step S904, and the search direction acquired in step S801. The focus lens movable range is a range from a position shifted (away) from the present position by the offset amount in the search direction to a driving end of the focus lens 104 in the search direction (an end in terms of control or an end of a machine). The camera MPU 125, which has calculated the focus lens movable range, ends the present processing.

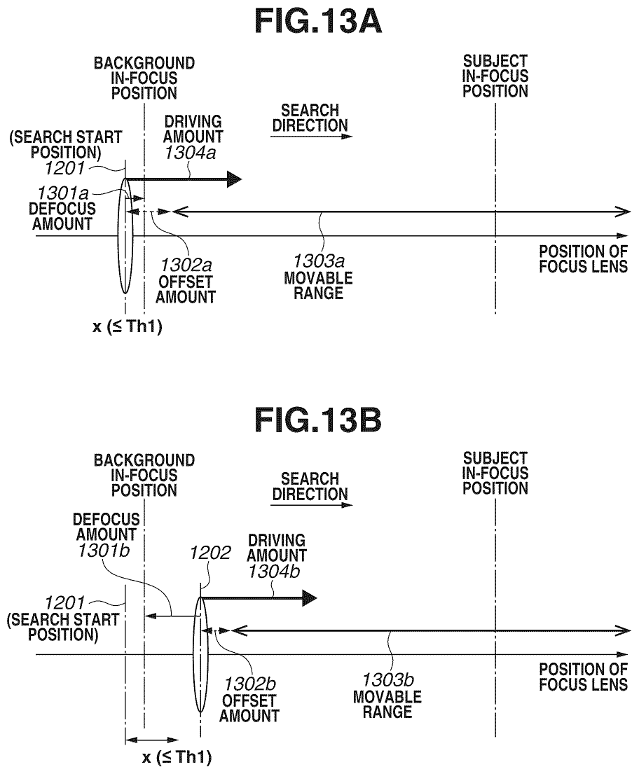

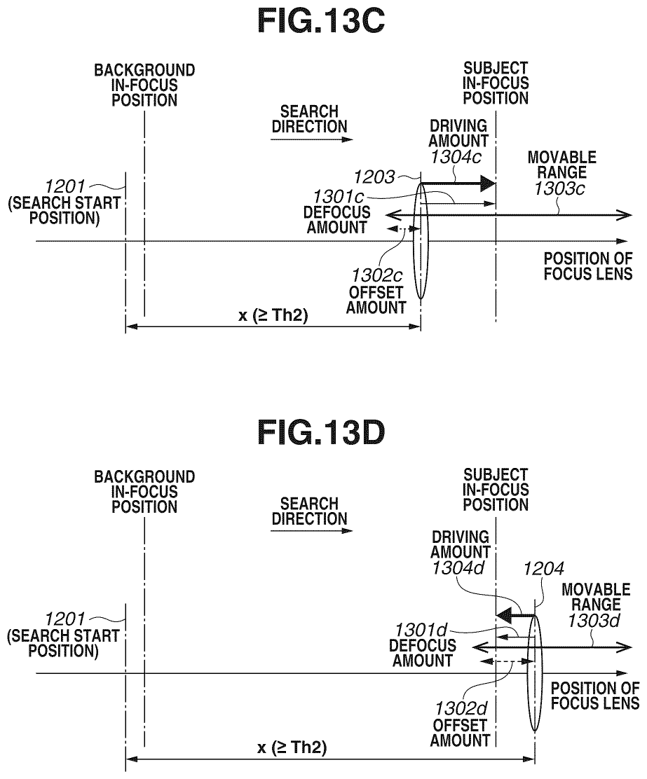

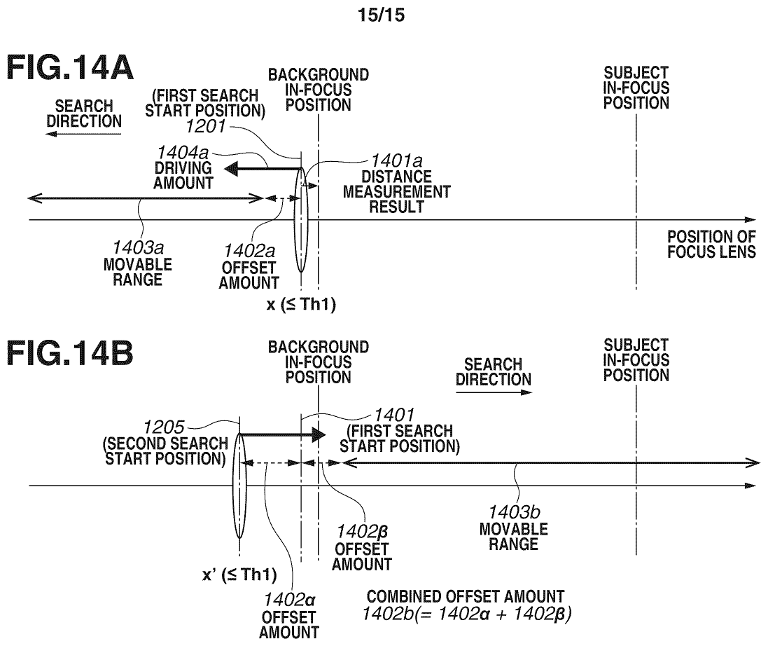

FIGS. 13A to 13D each illustrate a relationship among the search direction, the search start position, the focus lens position, the focus lens movable range, the defocus amount, and the focus lens driving amount in a case where an instruction regarding a first search direction is provided and thereafter the instruction regarding the first search direction is provided anew. FIGS. 14A and 14B are views each illustrating a relationship among the search direction, the search start position, the focus lens position, and the focus lens movable range in a case where the instruction regarding the first search direction is erroneously provided and thereafter an instruction regarding a second search direction, which is an opposite direction of the first search direction, is provided anew. Focus positions (present positions) 1201 to 1204 in FIGS. 13A to 13D, 14A, and 14B correspond to positions 1201 to 1204 illustrated in FIG. 12.

A basic operation after the instruction regarding the search direction is provided will be described with reference to FIGS. 13A to 13D.

FIG. 13A illustrates a state at the start of search, and the focus lens 104 is located at the search start position as the present position 1201. In this state, a relation of x (=0)≤Th1 holds. Hence, an offset amount 1302a is set in a direction that is identical to the search direction based on the focus detectable range, the aperture value, the focus sensitivity, and the difference x (step S904). A focus lens movable range 1303a is set at a position shifted from the search start position by the offset amount 1302a in the search direction. In this state, a defocus amount 1301a to the background in-focus position is detected. However, the background in-focus position as the target position of the focus lens 104 based on the defocus amount 1301a is outside the focus lens movable range 1303a. Hence, the defocus amount 1301a is not used, and a predetermined amount for search is set as a focus lens driving amount 1304a (step S806).

The focus lens movable range shifted from the search start position (present position) by the offset amount in the search direction is set. This makes it possible to search for the subject in-focus position without focusing on the background even in a case where the search start position is in the opposite direction of the search direction with respect to the background in-focus position.

FIG. 13B illustrates a state where the focus lens 104 has moved from the search start position to the present position 1202 that is closer to the subject in-focus position than the background in-focus position. In this state, a relation of x (>0)≤Th1 holds. Hence, an offset amount 1302b is set in a direction that is identical to the search direction based on the focus detectable range, the aperture value, the focus sensitivity, and the difference x (step S904). A focus lens movable range 1303b is set at a position shifted from the present position 1202 by the offset amount 1302b in the search direction. Since the difference x is larger than that in the state illustrated in FIG. 13A, the offset amount 1302b is smaller than the offset amount 1302a. Even in this state, a defocus amount 1301b to the background in-focus position is detected. However, the background in-focus position as the target position of the focus lens 104 based on the defocus amount 1301b is outside the focus lens movable range 1303b. Hence, the defocus amount 1301b is not used, and the predetermined amount for search is set as a focus lens driving amount 1304b (step S806). The focus lens driving amount 1304b is identical to the focus lens driving amount 1304a illustrated in FIG. 13A, but may be different from the focus lens driving amount 1304a such as an amount smaller than the focus lens driving amount 1304a.

The focus lens movable range shifted by the offset amount from the focus lens position after the start of search is set. This makes it possible to search for the subject in-focus position without focusing on the background even in a case where the detected defocus amount 1301a is a defocus amount with respect to a position within the focus lens movable range (1303a) set at the start of search.

In step S905 in FIG. 9, the camera MPU 125 determines whether the difference x is a predetermined second threshold Th2 (>Th1) or more. In a case where the difference x is the second threshold Th2 or more (YES in step S905), the processing proceeds step S906. In a case where the difference x is not the second threshold Th2 or more (NO in step S905), the processing proceeds step S908.

In step S906, the camera MPU 125 acquires a driving speed of the focus lens 104 and a focus detection period.

In step S907, the camera MPU 125 calculates an offset amount in the opposite direction of the search direction acquired in step S801 based on the driving speed and the focus detection period acquired in step S906, and furthermore, based on the difference x calculated in step S901. The offset amount here is set in consideration of a case where the position of the focus lens 104 goes past the subject in-focus position during the search due to the relationship of a driving speed V of the focus lens 104 and a focus detection period T, and is calculated by, for example, the following Expression (2), where R is a predetermined gain value:

$$Offset amount = β vTx \qquad ( 2 )$$

A driving amount of the focus lens 104 between frames in which focus detection is performed is calculated by multiplication of the driving speed v by the focus detection period T. Since the above-mentioned driving amount of the focus lens 104 between the frames is a maximum amount in which the position of the focus lens 104 goes past the subject in-focus position, the offset amount is set using the driving amount as a reference. There is a higher possibility that the position of the focus lens 104 goes past the subject in-focus position with increasing distance from the search start position. Hence, increasing the offset amount in proportion to the difference x between the search start position and the present position of the focus lens 104 makes it easier to cause the subject in-focus position to fall within the movable range even in a case where the position of the focus lens 104 goes beyond the subject in-focus position. That is, since there is a lower possibility that the position of the focus lens 104 goes past the subject in-focus position at the start of search, a range is narrowed to lower the risk that focus returns to the background. Once the focus lens 104 is away from the start position, there is a lower risk that focus returns to the background and there is a higher risk that the position of the focus lens 104 goes past the subject in-focus position. Thus, the movable range is widened in the search start direction. This causes the subject in-focus position to fall within the movable range even if the focus lens 104 goes past the subject in-focus position. The above-mentioned method of calculating the offset amount is merely an example, and the offset amount may be calculated by another method. For example, the offset amount (that is, the focus lens movable range) may be set based on only either the driving speed of the focus lens 104 or the focus detection period.

In step S908, the camera MPU 125 sets the offset amount at 0. The processing then proceeds to step S909, in which the camera MPU 125 calculates the focus lens movable range as described above, and the present processing then ends.

FIG. 13C illustrates a state where the focus lens 104 moves to the present position 1203 that is closer to the subject in-focus position than the position in the state illustrated in FIG. 13B. In this state, a relation of x>TH2 holds. Hence, an offset amount 1302c is set in the opposite direction of the search direction based on the driving speed of the focus lens 104, the focus detection period, and the difference x (step S907). A focus lens movable range 1303c is set in the search direction from a position shifted from the present position 1203 by the offset amount 1302c in the opposite direction of the search direction. In this state, a defocus amount 1301c to the subject in-focus position is detected, and the subject in-focus position as the target position of the focus lens 104 based on the defocus amount 1301c is within the focus lens movable range 1303c. Hence, a focus lens driving amount 1304c is set based on the defocus amount 1301c (step S805).

In this manner, the focus lens movable range is set in the search direction from the position shifted from the present position of the focus lens 104 by the offset amount in the opposite direction of the search direction. This makes it possible to drive the focus lens 104 and focus the focus lens 104 on the subject based on the defocus amount detected at a timing at which the subject in-focus position is within the focus lens movable range.

FIG. 13D illustrates a state where the focus lens 104 moves to the present position 1204 at which the focus lens 104 goes past the subject in-focus position. Even in this state, a relation of x≥Th2 holds. Hence, an offset amount 1302d is set in the opposite direction of the search direction based on the driving speed of the focus lens 104, the focus detection period, and the difference x (step S907). A focus lens movable range 1303d is set in the search direction from a position shifted from the present position 1204 by the offset amount 1302d in the opposite direction of the search direction. Since the difference x is larger than that in the state illustrated in FIG. 13C, the offset amount 1302d is larger than the offset amount 1302c. In this state, a defocus amount 1301d to the subject in-focus position that is located in the opposite direction of the search direction is detected, and the subject in-focus position as the target position of the focus lens 104 based on the defocus amount 1301d is within the focus lens movable range 1303d. Hence, a focus lens driving amount 1304d is set based on the defocus amount 1301d (step S806).

In this manner, the focus lens movable range is set in the search direction from the position of the focus lens 104 shifted from the present position of the focus lens 104 by the offset amount in the opposite direction of the search direction. This makes it possible to drive the focus lens 104 and focus the focus lens 104 on the subject based on the defocus amount even in a case where the focus lens 104 goes past the subject in-focus position in the search direction.

A description will be now be provided, with reference to FIGS. 14A and 14B, of an operation performed in a case where the instruction regarding the first search direction is erroneously provided and the instruction regarding the second search direction is provided anew during a search operation in response to the instruction regarding the first search direction. An operation in FIG. 14B or subsequent operations are similar to those illustrated in FIGS. 13C to 13D.

FIG. 14A illustrates a state at the start of search similarly to FIG. 13A, but the search direction is different from that in FIG. 13A. The focus lens 104 is located at a first search start position, as the present position 1201, at which the instruction regarding the first search direction is provided. In this state, a relation of x (=0)≤Th1 holds. Hence, an offset amount 1402a is set in a direction that is identical to the search direction based on the focus detectable range, the aperture value, the focus sensitivity, and the difference x (step S904). A focus lens movable range 1403a is set in the search direction from a position shifted from the search start position by the offset amount 1402a. In this state, a defocus amount 1401a to the background in-focus position is detected. However, the background in-focus position as the target position of the focus lens 104 based on the defocus amount 1401a is outside the focus lens movable range 1403a. Hence, the defocus amount 1401a is not used, and the predetermined amount for search is set as a focus lens driving amount 1404a (step S806).

FIG. 14B illustrates an operation performed when the instruction regarding the search direction is erroneously provided and the instruction regarding the search direction is provided anew. Unlike FIG. 13B, FIG. 14B illustrates a case where the focus lens 104 moves from the search start position to a position 1205 in the opposite direction from the background in-focus position, and the instruction regarding the search direction is provided anew. Assume that a direction that is instructed by the instruction regarding the search direction is closer to the subject in-focus position from the position 1205 than that in FIG. 14A.

A present position x′ at this time is a position in a case where the instruction regarding the search direction is provided with respect to a direction that is different from an intended search direction, and the instruction regarding the search direction is provided anew. Hence, assume that the offset amount is an offset amount 1402a from the first search start position as the present position 1201 to a second search start position as the present position 1205 in FIG. 14A.

In a case where the instruction regarding the search direction is provided at the second search start position, as the present position 1205, at which the instruction regarding the second search direction has been provided, a relation of x′(>0)≤Th1 holds. Hence, a combined offset amount 1402b is calculated from an offset amount 1402a and an offset amount 14020 that is set in the direction that is identical to the search direction based on the focus detectable range, the aperture value, the focus sensitivity, and the difference x′. The offset amount 14020 calculated herein is the offset amount 1302a illustrated in FIG. 13A. A focus lens movable range 1403b is set at a position shifted from a present position 1402 by the combined offset amount 1402b in the search direction.

An actual offset amount is larger than that in the state illustrated in FIG. 14A by the offset amount 1402a, but the calculated offset amount 14020 is equivalent to the offset amount 1302a. As a result, the instruction regarding the search direction in FIG. 14B is similar to that in FIG. 13A. A focus lens driving amount 1404b is identical to the focus lens driving amount 1404a illustrated in FIG. 14A, but may be different from the focus lens driving amount 1404a such as an amount smaller than the focus lens driving amount 1404a.

In the present exemplary embodiment, the description has been provided of the case where the instruction regarding the first search direction is provided, and thereafter the instruction regarding the second search direction is provided during a first search operation. However, the search may be performed based on the instruction regarding the second search direction if time since the instruction regarding the first search direction is provided until the second instruction regarding the second direction is provided is within predetermined time.

As described above, in the present exemplary embodiment, ingenuity is exercised in setting of the focus lens movable range in a case where the instruction regarding the first search direction is erroneously provided and the instruction regarding the second search direction is provided anew during a search operation in response to the instruction regarding the first search direction. That is, the present exemplary embodiment has a configuration of setting the focus lens movable range shifted by the offset amount in consideration of the offset amount 1402a from the focus lens position after the start of the search operation in response to the instruction regarding the second search direction. This makes it possible to search for the subject in-focus position without focusing on the background even in a case where the detected defocus amount 1401a is within the focus lens movable range (1403b) set after the start of search. Hence, it is possible to perform appropriate search AF for the subject desired by the user, and promptly obtain an in-focus state in which focus is placed on the subject.

A second exemplary embodiment will now be described. In the second exemplary embodiment, the imaging system 10 controls a driving speed of the focus lens 104 depending on an imaging method or an imaging state.

A configuration regarding the imaging system 10 and the image pickup device 122 in the second exemplary embodiment and imaging processing are identical to those in the first exemplary embodiment. The positional relationship between the subject and the background, the subject signal, the background signal, and furthermore, the relationship between the focus lens position and the focus detection result are also similar to those in the first exemplary embodiment.

### <Search AF Processing>

In the present exemplary embodiment, in driving of the focus lens 104, the camera MPU 125 further controls a driving speed based on information regarding whether an imaging method set by the user is a still-image capturing mode or a moving-image capturing mode.

In a case where the still-image capturing mode is selected by the user, in driving of the focus lens 104 to be executed in step S706 in FIG. 7, the camera MPU 125 sets the driving speed at a high speed because recording is not performed during search. The camera MPU 125 transmits the set driving speed of the focus lens 104 and the focus lens driving amount set in step S703 or step S705 to the lens MPU 117 and causes the lens MPU 117 to drive the focus lens 104.

In contrast, the following processing is performed as described below in a case where the moving-image capturing mode is selected by the user.

The camera MPU 125 acquires information regarding an imaging state indicating whether the imaging state is a waiting state before moving-image recording is started in a case where the moving-image capturing mode has been set by the user, or a recording state after moving-image recording is started in a case where the moving-image capturing mode has been set by the user. The camera MPU 125 controls the driving speed of the focus lens 104.

Specifically, in a case where the information regarding the imaging state indicates the waiting state, the recording is not performed. Thus, the camera MPU 125 sets the driving speed of the focus lens 104 at the high speed similarly to the case where information regarding an imaging method indicates the static-image capturing. In the case where the imaging state is the recording state, since recording is performed to include the search operation, the camera MPU 125 prioritizes quality of moving images to set the driving speed of the focus lens 104 at a speed from a medium speed to low speed.

In a case where the information regarding the imaging method indicates moving-image capturing, the camera MPU 125 may uniformly set the driving speed of the focus lens 104 at the speed from the medium speed to the low speed regardless of the information regarding the imaging state. Assuming that a section of the offset amount 1402a is an unintended section, the camera MPU 125 may set the driving speed at the high speed only in the section of the offset amount 1402a. Furthermore, in a case where the driving speed of the focus lens 104 at the time of moving-image capturing is designated by the user, the camera MPU 125 may set the designated driving speed.

As described above, in the present exemplary embodiment, controlling the driving speed of the focus lens 104 according to the information regarding the imaging method or the information regarding the imaging state makes it possible to perform the search operation appropriate for the still-image capturing mode or the moving-image capturing mode.

According to the present exemplary embodiment, it is possible to perform an appropriate search operation in focus adjustment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-079797, filed May 15, 2024, which is hereby incorporated by reference herein in its entirety.

What is claimed is:

1. A focus control apparatus comprising:
one or more processors that execute a program stored in a memory, the one or more processors when executing the program cause the focus control apparatus to:
perform focus detection;
control driving of a focus lens included in an optical system based on a focus detection result obtained by the focus detection; and
set a movable range based on a search direction of the focus lens in response to a user's instruction and a position of the focus lens,
wherein, in a case where an instruction regarding a first search direction is provided and thereafter an instruction regarding a second search direction that is different from the first search direction is provided, the movable range is set based on the second search direction and a first focus lens position when the instruction regarding the first search direction is provided.

2. The focus control apparatus according to claim 1, wherein, in a case where the instruction regarding the second search direction is provided within a predetermined time after the instruction regarding the first search direction is provided, the movable range is set based on the second search direction and the first focus lens position when the instruction regarding the first search direction is provided.

3. The focus control apparatus according to claim 1, wherein the movable range is set based on optical information regarding the optical system.

4. An imaging apparatus comprising:
the focus control apparatus according to claim 1; and
an image pickup device configured to capture an image of a subject via the optical system.

5. The imaging apparatus according to claim 4, wherein a driving speed of the focus lens is changed depending on whether an operation mode is a still-image capturing mode or a moving-image capturing mode.

6. The imaging apparatus according to claim 4, wherein, in a case where a moving-image capturing mode is set, a driving speed of the focus lens is changed depending on whether an imaging state is a waiting state before moving-image recording is started or a recording state after the moving-image recording is started.

7. A focus control method comprising:
performing focus detection;
controlling driving of a focus lens included in an optical system based on a focus detection result obtained by the focus detection; and
setting a movable range based on a search direction of the focus lens in response to a user's instruction and a position of the focus lens,
wherein, in a case where an instruction regarding a first search direction is provided and thereafter an instruction regarding a second search direction that is different from the first search direction is provided, the movable range is set based on the second search direction and a first focus lens position when the instruction regarding the first search direction is provided.

8. A non-transitory computer-readable storage medium that stores a program to cause a computer to execute the focus control method according to claim 7.
